(19) United States
(12) Patent Application Publication
(10) Pub. No.: US 2026/0262883 A1
(43) Pub. Date: Sep. 10, 2026

(54) FROTHING SYSTEMS AND COMPONENTS THEREOF

(71) Applicant: Vita-Mix Management Corporation, Olmsted Township, OH (US)

(72) Inventors: David J. Kolar, Olmsted Township, OH (US); Casey T. Zale, Olmsted Township, OH (US); Matthew J. Dugan, Olmsted Township, OH (US)

(73) Assignee: Vita-Mix Management Corporation, Olmsted Township, OH (US)

(21) Appl. No.: 19/556,503

(22) Filed: Mar. 4, 2026

Related U.S. Application Data
(60) Provisional application No. 63/767,357, filed on Mar. 5, 2025.

(51) Int. Cl. A47J 43/046; A47J 43/07; A47J 43/08

(52) U.S. Cl. CPC A47J 43/046; A47J 43/0722; A47J 43/0727; A47J 43/085

(57) ABSTRACT

A frothing system is disclosed. The frothing system includes a container having a base and at least one side wall extending from the base. A frothing device is attached to the base of the container. The frothing device includes a spindle having a first spindle end and a second spindle end. The spindle defines and is rotatable about a spindle axis. A support of the frothing device has a first support portion coupled to the first spindle end and a second support portion spaced from the first spindle end. An agitator of the frothing device is on the second support portion and adjacent to the base. The agitator is positioned closer to the base than the first support portion.

### CROSS-REFERENCE TO RELATED APPLICATION

This application claims priority from U.S. Provisional Application No. 63/767,357, filed Mar. 5, 2026, for “Frothing Apparatus and Blending Container Including the Same,” which is hereby incorporated by reference in its entirety including the drawings.

### TECHNICAL FIELD

The present specification generally relates to frothing systems and the components thereof and, more specifically, to frothing devices, containers for frothing systems, and frothing systems having container and frothing devices.

### BACKGROUND

Frothing systems are often used to generate foam (e.g., cold foam), and generally include a base with a motor, and a container with an operable agitator disposed therein. A user inserts ingredients within the container to be frothed by the rotation of the agitator. The container is positioned on the base as a user controls the operation of the motor within the base to rotate the agitator within the container to froth the ingredients therein. Such frothing systems may not be usable in large formats due to dimensional constraints. In addition, such frothing systems typically utilize a specialized motor for driving the agitator, which increases the cost of manufacturing.

### SUMMARY

In one embodiment, a frothing system is disclosed. The frothing system includes: a container having a base and at least one side wall extending from the base; and a frothing device attached to the base of the container. The frothing device includes: a spindle having a first spindle end and a second spindle end, the spindle defining and being rotatable about a spindle axis; a support having a first support portion coupled to the first spindle end and a second support portion spaced from the first spindle end; and an agitator on the second support portion and adjacent to the base, the agitator positioned closer to the base than the first support portion.

In another embodiment, a frothing system is disclosed. The frothing system includes: a system base having a motor; a container coupled to the system base, the container includes: a base; at least one side wall extending from the base and terminating at an open end of the container; and an outlet opening extending through the at least one side wall adjacent the base surface and through which contents within the container flow out from the container; and a frothing device coupled to the base of the container, the frothing device includes: a spindle having a first spindle end and a second spindle end, the spindle defining a spindle axis, the second spindle end being coupled to the motor and rotatable via the motor about the spindle axis; a support having a first support portion coupled to the first spindle end and a second support portion spaced from the first spindle end; and an agitator on the second support portion, the agitator positioned closer to the base than the first support portion, and wherein the coupling of the first support portion to the first spindle end rotationally fixes the second support portion and the agitator to the spindle.

In yet another embodiment, a frothing device is disclosed. The frothing device includes: a spindle having a first spindle end and a second spindle end, the spindle defining a spindle axis; a support comprising: a ring coupled to the first spindle end, the ring extending about the spindle axis; and a ring-shaped body connected to the ring and spaced from the first spindle end, the ring-shaped body having a greater diameter than a diameter of the ring, the ring-shaped body extending about the spindle axis; and an agitator mounted to or formed with the ring-shaped body, the agitator being spaced from the first spindle end.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and are not intended to limit the subject matter defined by the claims. The following detailed description of the illustrative embodiments can be understood when read in conjunction with the following drawings, where like structure is indicated with like reference numerals and in which:

FIG. 1 schematically depicts a frothing system, according to one or more embodiments shown and described herein;

FIG. 2 schematically depicts a cross-sectional view of a frothing device of the frothing system of FIG. 1, according to one or more embodiments shown and described herein;

FIG. 3 schematically depicts a perspective side view of the frothing device of the frothing system of FIG. 1, according to one or more embodiments shown and described herein;

FIG. 4 schematically depicts a perspective side view of another embodiment of the frothing device of FIG. 1, according to one or more embodiments shown and described herein;

FIG. 5 schematically depicts a perspective side view of yet another embodiment of the frothing device of FIG. 1, according to one or more embodiments shown and described herein;

FIG. 6 schematically depicts a perspective top view of a container of the frothing system of FIG. 1, according to one or more embodiments shown and described herein;

FIG. 7 schematically depicts a cross-sectional view of the container of FIG. 6, according to one or more embodiments shown and described herein;

FIG. 8 schematically depicts a top view of the container of FIG. 6, according to one or more embodiments shown and described herein;

FIG. 9 schematically depicts a cross-sectional view of a portion of the frothing system of FIG. 1, according to one or more embodiments shown and described herein;

FIG. 10 schematically depicts a top view of a portion of the frothing system of FIG. 1, according to one or more embodiments shown and described herein;

FIG. 11 schematically depicts a perspective top view of another embodiment of the container of the frothing system of FIG. 1, according to one or more embodiments shown and described herein;

FIG. 12 schematically depicts a cross-sectional view of the container of FIG. 11, according to one or more embodiments shown and described herein;

FIG. 13 schematically depicts a top view of the container of FIG. 11, according to one or more embodiments shown and described herein;

FIG. 14 schematically depicts a perspective top view of another embodiment of the container of the frothing system of FIG. 1, according to one or more embodiments shown and described herein;

FIG. 15 schematically depicts a cross-sectional view of the container of FIG. 14, according to one or more embodiments shown and described herein;

FIG. 16 schematically depicts a top view of the container of FIG. 14, according to one or more embodiments shown and described herein;

FIG. 17 schematically depicts a cross-sectional view of the container of FIG. 14 having a plug removably inserted into an outlet opening of the container, according to one or more embodiments shown and described herein;

FIG. 18 schematically depicts a cross-sectional view of yet another embodiment of the container of the frothing system of FIG. 1, according to one or more embodiments shown and described herein;

FIG. 19 schematically depicts a top view of the container of FIG. 18, according to one or more embodiments shown and described herein; and

FIG. 20 schematically depicts a top view of yet another embodiment of the container of the frothing system of FIG. 1, according to one or more embodiments shown and described herein.

### DETAILED DESCRIPTION

Embodiments described herein are directed to a frothing system including a container and a frothing device. The container has a base and at least one side wall extending from the base. The frothing device is (e.g., removably) attached to the base of the container. The frothing device includes a spindle, a support, and an agitator. The spindle has a first spindle end and a second spindle end. The spindle defines and is rotatable about a spindle axis. The support has a first support portion coupled to the first spindle end and a second support portion spaced from the first spindle end. The second support portion is adjacent the base. An agitator is on the second support portion. The agitator is positioned closer to the base than the first support portion. Positioning agitator such that it is adjacent the base and closer to the base than the portion of the support that is connected to the first end of the spindle minimizes the retention of un-processed and/or processed materials within the container and provides for a more efficient processing of the ingredients.

Embodiments described herein are also directed to a frothing system that includes a system base having a motor, a container (e.g., removably) coupled to the system base, and a frothing device (e.g., removably) coupled to the container. The container is coupled to the system base, the container includes: a base, at least one side wall extending from the base and terminating at an open end of the container; and an outlet opening extending through the at least one side wall adjacent the base surface and through which contents within the container flow out from the container. Having such an outlet opening provides for a less cumbersome dispensing process as the container dispenses without being picked up and tipped.

Embodiments are also directed to a frothing device. The frothing device includes a spindle, a support, and an agitator. The spindle has a first spindle end and a second spindle end. The spindle defines a spindle axis. The support comprises a ring and a ring-shaped body. The ring is coupled to the first spindle end. The ring extends about the spindle axis. The ring-shaped body is connected to the ring and spaced from the first spindle end. The ring-shaped body has a greater diameter than a diameter of the ring. The ring-shaped body extends about the spindle axis. The agitator is mounted to or formed with the ring-shaped body. The agitator is spaced from the first spindle end. Spacing the agitator from the first spindle end minimizes the retention of un-processed and/or processed materials within the container and provides for a more efficient processing of the ingredients.

Various embodiments of the frothing system and the components thereof are described in more detail herein. Whenever possible, the same reference numerals will be used throughout the drawings to refer to the same or like parts.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

The term “at least one of” in the context of, e.g., “at least one of A, B, and C” refers only A, only B, only C, or any combination of A, B, and C.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a ten-percent margin.

Here and throughout the specification and claims, range limitations are combined and interchanged; such ranges are identified and include all of the sub-ranges contained therein unless context or language indicates otherwise. For example, all ranges disclosed herein are inclusive of the endpoints, and the endpoints are independently combinable with each other.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation; and the number or type of embodiments described in the specification.

Frothing systems have been utilized to produce foam (e.g., cold foam) for topping various types of drinks (e.g., coffee and matcha). Traditional foam generation methods involve adding certain ingredients to a container that includes a frothing device at least partially therein. The ingredients can include, e.g., milk or a milk alternative (e.g., skim milk, 1% milk, whole milk, oat milk, almond milk, soy milk, or coconut milk), one or more sweeteners (e.g., simple syrup, vanilla syrup, honey, maple syrup, sugar, and/or stevia), one or more flavorings (e.g., vanilla, caramel, hazelnut, cinnamon, nutmeg, matcha, and/or cocoa powder), one or more stabilizers (e.g., gelatin, agar agar, carrageenan, and/or guar gum), and/or on or more emulsifiers (e.g., mono-and/or diglycerides). At least an agitator of the frothing device is rotated at a high speed via a motor to mix the ingredients and incorporate air into the mixture, thereby producing a foam.

Despite producing foam as intended, existing frothing systems have some drawbacks. Existing frothing systems have a tendency to retain un-processed ingredients and/or generated foam at the bottoms of the containers under the agitators. This retention is largely due to the agitators being spaced at appreciable distances from the bottoms of the containers, thereby permitting un-processed ingredients or generated foam to be “caught” under the agitators. Further, the containers are typically designed to be picked up and at least partially tipped to pour the generated foam out from the containers. Picking up and tipping containers can be cumbersome and heavy and can lead to potential accidents, such as the dropping of system components and/or the spillage of materials. This is especially true when considering the use of frothing systems in more industrialized settings such as food service industries, manufacturing, or the like. These shortcomings highlight a need for innovative solutions for generating and/or dispensing foam in a manner that minimizes the retention of un-processed and/or processed ingredients within a container, provides for a more efficient processing of ingredients, and that eases the dispensing process.

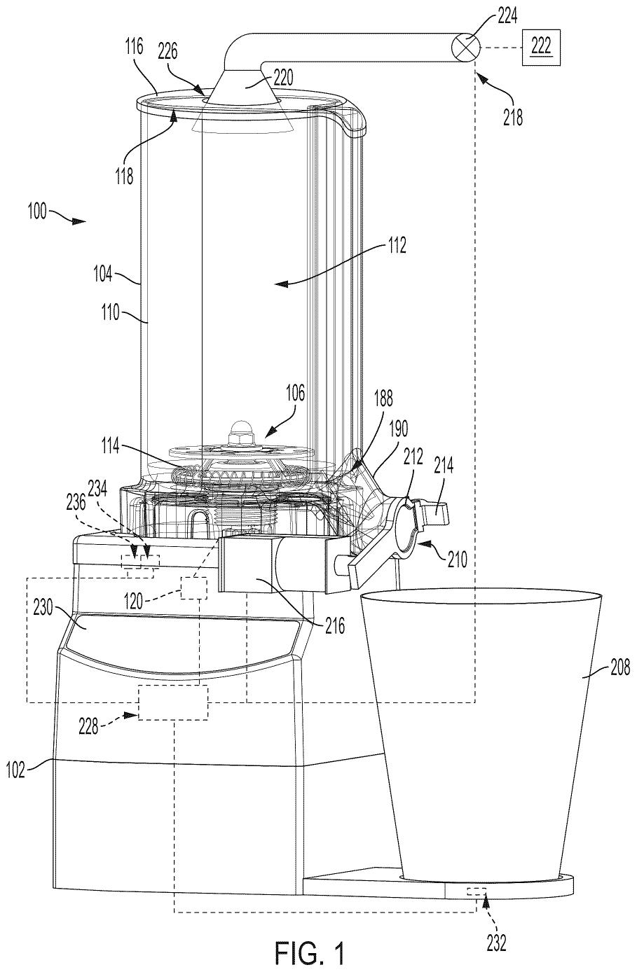

Referring now to FIG. 1, a frothing system 100 for generating and dispensing foam (e.g., cold foam) is depicted. Although the frothing system 100 and its components are described as being utilized to produce and dispense foam, the frothing system 100 may be utilized to produce other substances via the selection of ingredients and/or a particular operation of the components of the frothing system 100. Furthermore, the frothing system 100 may be used or be adapted to be used for blending and/or food processing applications. The frothing system 100 is shown as being a free-standing construction, although the frothing system 100 may be a more portable system in other embodiments.

The frothing system 100 generally includes a system base 102, a container 104, and a frothing device 106, although greater or fewer number of components may be included without departing from the scope of the present disclosure.

The container 104 includes one or more side walls 110 that at least partially define a frothing chamber 112 in which an agitator 114 of the frothing device 106 is received. Further, ingredients may be added to the frothing chamber 112 for processing (e.g., frothing). As shown in FIG. 1, the frothing system 100 includes a lid 116 that may be removably attached to the container 104 at an open end 118 of the container 104 to enclose or at least partially enclose the frothing chamber 112. However, it should be appreciated that the frothing system 100 may not include the lid 116 in embodiments where the container 104 is maintained open at the open end 118.

While the container 104 depicted in FIG. 1 is shown as a large-format system, the container 104 may be a single-serving style container, such as for example, of a type where the container 104 is filled, the frothing device 106 is attached to the container 104, and the container 104 is inverted and placed on the system base 102 for frothing. As can be appreciated, the container 104 depicted in FIG. 1 is one illustrative shape, and the container 104 may be a different size and/or shape without departing from the scope of the present disclosure.

The system base 102 includes a motor 120 and a power source (not shown) that is electrically coupled to the motor 120. In some aspects, the motor 120 may be, but is not limited to, an electric motor or the like. The power source includes a switch that is configured to inhibit power from being delivered from the power source to the motor 120 and/or to other powered components of the frothing system 100. As described in more detail herein, the motor 120 drives the agitator 114 of the frothing device 106 when the frothing device 106 is properly interfaced with the container 104 and the system base 102. As a result, the agitator 114 may agitate or otherwise interact with materials within the frothing chamber 112. In particular, the agitator 114 may be configured to be removably coupled to and rotated by the motor 120, where such rotation generates a flow of ingredients within the frothing chamber 112. The flow of the ingredients may form a vortex of the ingredients within the frothing chamber 112. Without intending to be bound by theory, it is believed that the rotation of the agitator 114 may generate a vortex of the ingredients within the frothing chamber 112 that exhibits low-pressure, high-velocity flow that creates suction that pulls air into the ingredients to create a (e.g., dense) foam. Further, the agitator 114 may avoid high pressure within the ingredients that destroys air bubbles. In addition, high turbulence of the ingredients generated by agitator 114 may result in eddies forming within the ingredients that further pull air into the ingredients. The resulting vortex formed by rotation of the agitator 114 may result in ingredients riding along the one or more side walls 110 toward the open end 118 of the container 104 and folding back onto the agitator 114 to further pull air into the ingredients.

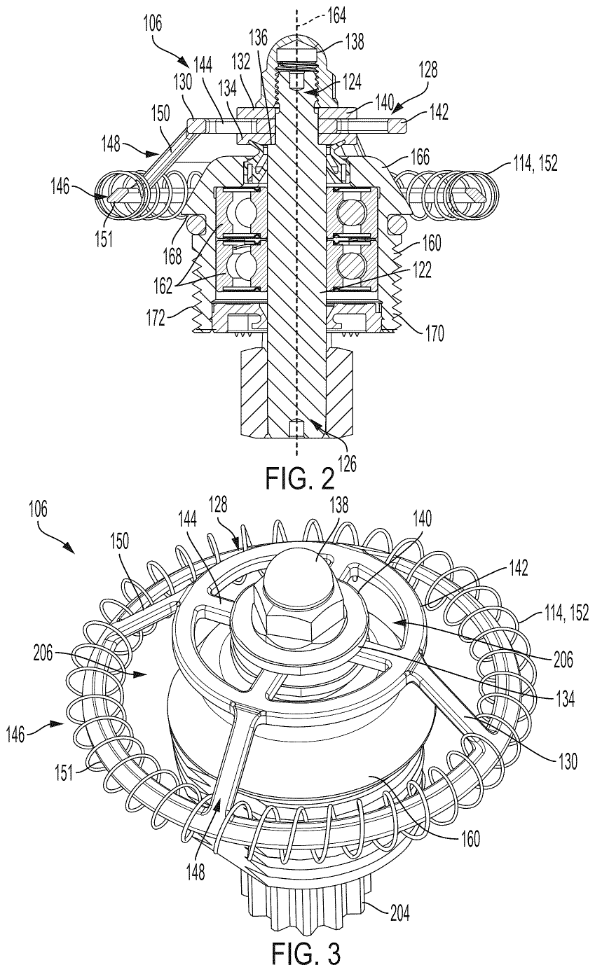

Referring now to FIG. 2, the frothing device 106 is depicted including a spindle 122 with opposite first and second spindle ends 124, 126. The first spindle end 124 is coupled to (e.g., removably coupled to) a first support portion 128 of a support 130. In the depicted embodiment, the first support portion 128 includes an inner ring 132 through which the first spindle end 124 extends when coupled thereto. A first washer 134 may be interposed between the inner ring 132 and a (e.g., annular) spindle lip 136 of the spindle 122 so as to provide a more stable interface or connection between the spindle 122 and the first support portion 128. In other embodiments, the first washer 134 may be omitted, and the inner ring 132 may be seated directly on the spindle lip 136.

The frothing device 106 may include a fastener 138 (here, a cap nut) that may be attached to (e.g., threadably attached to) the first spindle end 124 to removably secure the support 130 on the first spindle end 124. In the depicted embodiment, a second washer 140 may be interposed between the inner ring 132 and the fastener 138 to provide a more stable interface or connection between the spindle 122, the first support portion 128, and the fastener 138. In other embodiments, the second washer 140 may be omitted so that the inner ring 132 directly contacts the fastener 138.

The first support portion 128 may also include an outer ring 142 that is coaxial and planar with the inner ring 132 so as to surround the inner ring 132, though the outer ring 142 may be non-coaxial and/or non-planar with the inner ring 132 in other embodiments. The inner and outer rings 132, 142 are fixed to one another via one or more first support arms 144 (shown in FIG. 3 as a plurality of first support arms 144) that extend between and interconnect the inner and outer rings 132, 142.

A second support portion 146 of the support 130 is arranged opposite to the first support portion 128. In particular, the first support portion 128 is located at a first end of the support 130, and the second support portion 146 is located at an opposite second end of the support 130. The support 130 may include an intermediate support portion 148 to provide such spacing. For example, the support 130 may include an intermediate support portion 148 that extends between and interconnects the outer ring 142 and the second support portion 146. The intermediate support portion 148 may include one or more second support arms 150 (here, a plurality of second support arms 150) that extend at a decline from the outer ring 142 to the second support portion 146. The second support portion 146 thus is spaced from the first support portion 128 via the second support arms 150 of the intermediate support portion 148. Although the second support portion 146 is shown and described as being interconnected with the outer ring 142, the second support portion 146 may be interconnected with the inner ring 132 in embodiments that omit the outer ring 142.

When the support 130 is joined to the spindle 122 in the manner described above, the second support portion 146 is spaced from the first spindle end 124 and located between the first and second spindle ends 124, 126. The second support portion 146 may include a ring-shaped body 151 that extends around the spindle 122 when connected thereto. The ring-shaped body 151 of the second support portion 146, in other embodiments, may have any other suitable shape. As described above, the second support arms 150 extend at a decline from the outer ring 142 to the second support portion 146. The decline is in part due to the ring-shaped second support portion 146 having a larger diameter than that of the outer ring 142. In other embodiments, the diameter of the second support portion 146 may be the same as or smaller than that of the outer ring 142. The ring-shaped body 151 is coaxial with the outer ring 142 and the inner ring 132. In other embodiments, the ring-shaped body 151 may be non-coaxial with at least one of the outer ring 142 and the inner ring 132.

As shown in FIGS. 2-3, the support 130 thus is generally in the shape of a truncated cone, though the support 130 or any component thereof may have any other shape than the ones shown or described herein without departing from the scope of the present disclosure. The first support portion 128, the second support portion 146, and the intermediate support portion 148 also collectively define a one-piece construction. In other embodiments, the support 130 may be a multi-piece construction with at least one of the first support portion 128, the second support portion 146, and the intermediate support portion 148 being formed separately from and subsequently connected to at least one of the other components of the support 130.

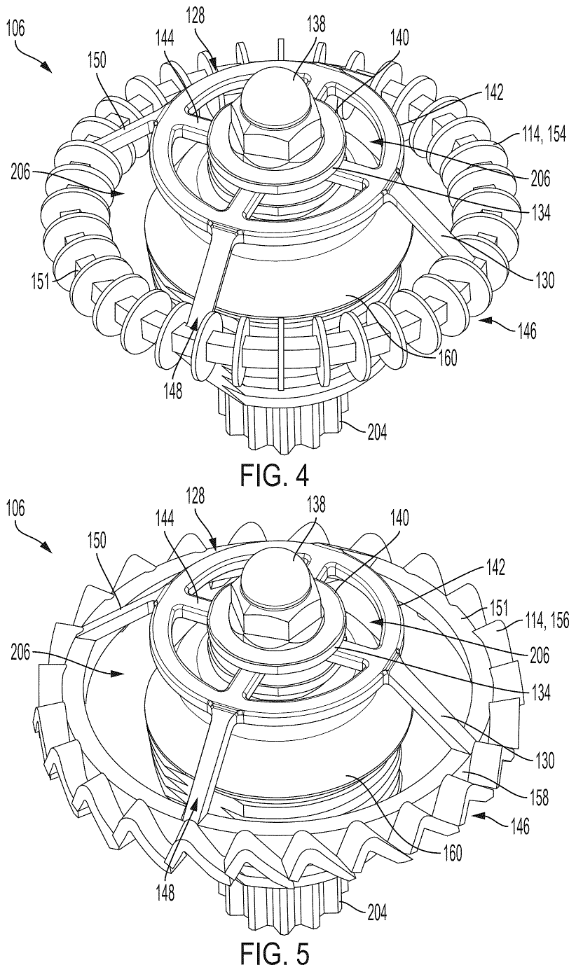

The agitator 114 of the frothing device 106 is coupled to the second support portion 146. In at least the embodiment shown in FIGS. 2-3, the agitator 114 is separate from and mounted to the second support portion 146. For example, as shown in FIGS. 2-3, the agitator 114 is a wire or spring wire 152 coiled about the second support portion 146. The agitator 114, in other embodiments, may be formed with the second support portion 146 as a single monolithic piece. For example, as shown in FIG. 4, the agitator 114 of a substantially similar embodiment of the frothing device (indicated at 106a in FIG. 4) may include one or more (here, a plurality of) disk-shaped elements 154 that are formed with and disposed along the ring-shaped body 151 of the second support portion 146. FIG. 5 depicts that the agitator 114 of another substantially similar embodiment of the frothing device (indicated at 106b in FIG. 4) may be in the form of a wave-shaped ring 156 that extends circumferentially around and is formed on an outer surface 158 of the ring-shaped body 151 of the second support portion 146. It should be appreciated that any of these frothing devices 106, 106a, 106b may be utilized with the container 104 and/or the system base 102 of FIG. 1, and/or with any other embodiment of the container 104 and/or the system base 102 disclosed herein or constructed in view of the teachings provided herein. Furthermore, individual components of each embodiment of the frothing device 106, 106a, 106b may be incorporated into each of the other embodiments whether expressly stated or not.

Although the agitator 114 is attached to the first support portion 128 via the second support portion 146 and the intermediate support portion 148, the agitator 114 may be connected to the first support portion 128 via the intermediate support portion 148 in embodiments that omit the second support portion 146. As an example, the coiled wire or spring wire 152 may be connected directly to the intermediate support portion 148 and connected to the first support portion 128 via the intermediate support portion 148 when the second support portion 146 is omitted. As another example, the wave-shaped ring 156 may be connected directly to the intermediate support portion 148 and connected to the first support portion 128 via the intermediate support portion 148 when the second support portion 146 is omitted. Furthermore, it is contemplated that in blending and/or food processing uses of the frothing system 100, the agitator 114 may additionally or instead include blades or other sharpened features.

Returning now to FIG. 2, the spindle 122 may extend from the first spindle end 124 through a housing 160 of the frothing device 106 to the second spindle end 126 and be arranged such that each of the first and second spindle ends 124, 126 are located outside the housing 160. The housing 160 may house one or more bearings 162 therein that permit the spindle 122 to rotate about a spindle axis 164 of the spindle 122 relative to the housing 160. The housing 160 may include a first housing portion 166 having a housing lip 168 and a second housing portion 170 extending from the first housing portion 166. The second housing portion 170 may include an external attachment feature 172 for removably securing the housing 160 (and, thus, the frothing device 106) to the container 104. In the depicted embodiment, the external attachment feature 172 includes threads.

The frothing device 106, and/or sub-components thereof, may be formed from metal, plastic, and/or any other suitable material(s) in any combination.

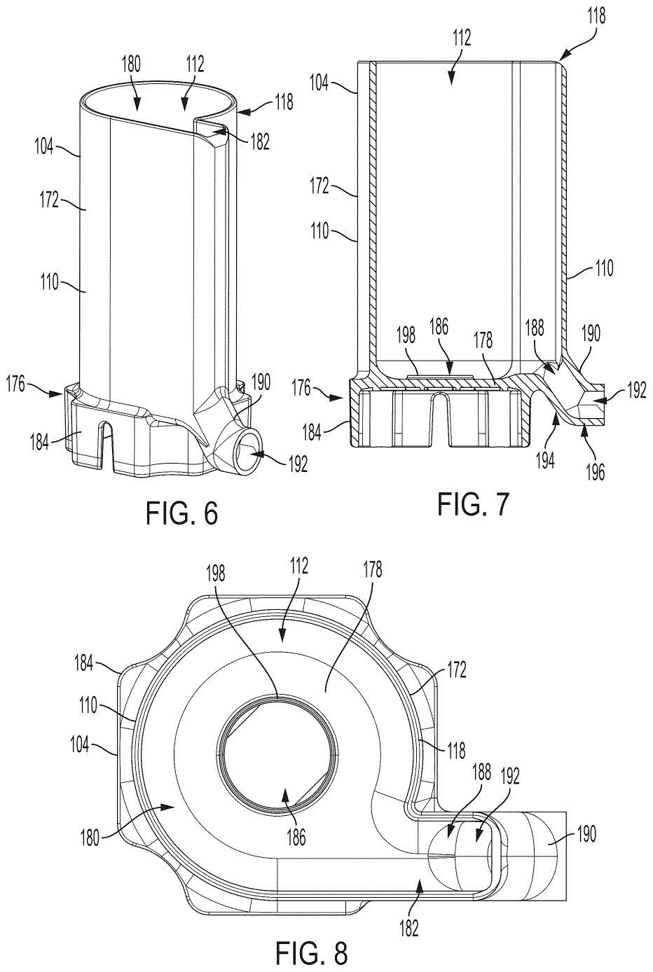

Referring now to FIGS. 6-8, the container 104 shown in FIG. 1 is depicted including a body 174 defining the open end 118. The body 174 includes a second end 176 opposite the open end 118, and the one or more side walls 110 (shown here as a plurality of side walls 110). The side walls 110 extend between the open end 118 and a base 178 (FIGS. 7-8) that is located at the second end 176. As described above, the base 178 and the side walls 110 define the frothing chamber 112 of the container 104. In some embodiments, the body 174 may be formed from a non-transparent material such as, for example, metal, stainless steel, plastic, and/or the like in any combination. In other embodiments, the body 174 may be formed from transparent material such as, for example, plastics, glass, and/or the like in any combination.

The side walls 110 of the container 104 of FIGS. 6-8 define a rounded portion 180 of frothing chamber 112 and a polygonal portion 182 of the frothing chamber 112, which extends from the rounded portion 180. The container 104 may have any other shape in other embodiments.

An apron or base attachment 184 is formed at the second end 176 of the body 174 for mounting the container 104 onto the system base 102 (FIG. 1). Accordingly, the base attachment 184 may include any suitable mechanism for attaching to the system base 102, such as clips, projections, latches, and the like. In other aspects, the base attachment 184 is sized to fit within a recess formed within the system base 102, and the system base 102 includes any suitable mechanism for attaching to the base attachment 184, such as clips, projections, latches, and the like. The base 178 may include an aperture 186 (FIGS. 7-8) extending from the frothing chamber 112 to the base attachment 184.

As shown in FIG. 7, the body 174 of the container 104 may include an outlet opening 188 through which the contents within the frothing chamber 112 may be dispensed or evacuated from the frothing chamber 112. In embodiments, the outlet opening 188 may extend through one of the side walls 110, a corner where two of the side walls 110 meet, and/or the base 178. In the embodiment depicted in FIG. 7, the outlet opening 188 extends through one of the side walls 110 defining the polygonal portion 182 and the base 178. The outlet opening 188 may extend at a decline so as to utilize gravity for the dispensing of the contents within the frothing chamber 112. In other embodiments, the outlet opening 188 may extend horizontally from one of the side walls 110, a corner where two of the side walls 110 meet, and/or the base 178.

The body 174 of the container 104 may further include a port 190 extending from the outlet opening 188. The port 190 defines an inner lumen 192 that is in fluid communication with the outlet opening 188 such that contents flowing through the outlet opening 188 pass through the port 190 before being dispensed from the container 104. In the example embodiment shown, the port 190 includes a first port portion 194 that extends at a decline from the outlet opening 188 and a second port portion 196 that extends substantially horizontally from the first port portion 194. In other embodiments, the port 190 may be constructed having one of the first and second port portions 194, 196.

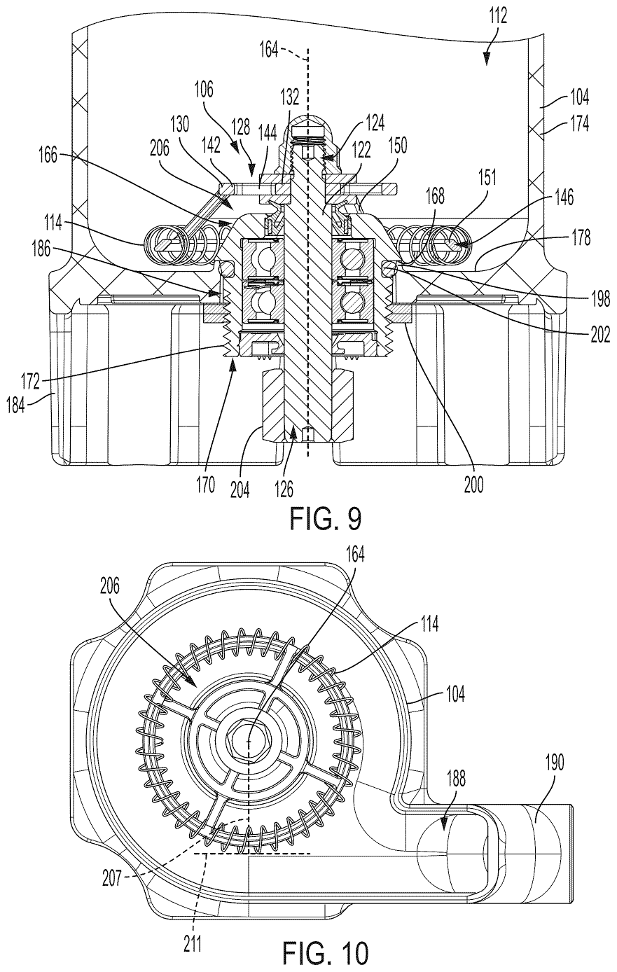

Referring now to FIG. 9, the frothing device 106 can be connected (e.g., removably connected) to the body 174 of the container 104 at the base 178. In particular, the frothing device 106 may be inserted into the frothing chamber 112 of the container 104 and through the aperture 186 until the housing lip 168 contacts a container lip 198 on the base 178 that surrounds and at least partially defines the aperture 186. In other embodiments, the housing lip 168 may contact the base 178 itself (e.g., when no such container lip 198 is provided) or may contact a sealing element (e.g., a gasket) seated on the housing lip 168 and/or the base 178. While the first housing portion 166 is located in the frothing chamber 112, the second housing portion 170 extends through the aperture 186 to the base attachment 184. At least a portion of the external attachment feature 172 thus is within the base attachment 184 when joined to the container 104. Once the frothing device 106 is in position, a fastener 200 (e.g., a nut) may be engaged (e.g., threadably engaged) to the external attachment feature 172 to secure the frothing device 106 to the container 104. One or more interfacing elements 202 (e.g., gaskets) may be interposed between the container 104 and the housing 160 to provide a fluid-tight seal therebetween and/or to reduce vibrations between the frothing device 106 and the container 104.

After the frothing device 106 is connected to the container 104, the container 104 may be removably seated on the system base 102 (FIG. 1) in a position in which the second spindle end 126, which is located in the base attachment 184, is operatively connected to the motor 120 (FIG. 1). The second spindle end 126 may thus include an attachment mechanism 204 (here, a splined coupler) that removably connects to the motor 120 or to an intermediate component between the motor 120 and the spindle 122.

In use, the motor 120 may be actuated to cause the spindle 122 to rotate about the spindle axis 164 at a selected or predetermined speed (e.g., at about 1,000 to 3,500 revolutions per minute “RPM” to produce foam) relative to the body 174 of the container 104. The support 130 and the agitator 114 rotate with the spindle 122 about the spindle axis 164 due to the connection of the first support portion 128 to the first spindle end 124 rotationally fixing the support 130 and the agitator 114 to the spindle 122. Accordingly, the agitator 114 may be rotated at the selected or predetermined speed via the motor 120 relative to the body 174 of the container 104 to mix any ingredients within the frothing chamber 112, incorporate air into the mixture, and thereby produce a (e.g., dense) foam in the frothing chamber 112.

It should be appreciated that the agitator 114 and the second support portion 146 are adjacent and in close proximity to the base 178 of the container 104, and the first support portion 128 is spaced further from the base 178 than the second support portion 146. The second support portion 146 being in closer proximity to the base 178 is due to the second support portion 146 being spaced from the first support portion 128 (e.g., where the support 130 is joined to the first spindle end 124). For example, the agitator 114 may be within about 0.4 inches to 0.5 inches of the base 178. The relatively low clearance between the agitator 114 and the base 178 helps ensure that all or most of the ingredients in the frothing chamber 112 are suitably processed by minimizing the amount of un-processed ingredients that can be retained adjacent the base 178 and below the agitator 114. Furthermore, the disposition of the agitator 114 in the above-described manner may also contribute to the processing of the ingredients due to the increase in shear forces and the like resulting from such a low clearance.

It should also be appreciated that support 130 includes a plurality of openings 206 (FIGS. 9-10) extending therethrough and defined by the inner ring 132, the first support arms 144, the outer ring 142, the second support arms 150, and the ring-shaped body 151 of the second support portion 146. These openings 206 permit the flow of ingredients and foam therethrough so as to at least reduce the amount of processed and unprocessed ingredients that are “caught” beneath the support 130 and the agitator 114. These openings 206 also help reduce the overall weight of the support 130, which advantageously reduces the power output utilized by the motor 120 to rotate the agitator 114 at the selected or preset RPM.

The mixing of the ingredients largely occurs at or adjacent to the agitator 114. Therefore, as shown in FIG. 10, the agitator 114 defines an effective radius (an example of which is indicated at 207 in FIG. 10) in the frothing chamber 112 that extends radially from the agitator 114 to the spindle axis 164 and where the mixing of the ingredients largely occurs in the frothing chamber 112. In the embodiment shown in FIG. 10, the outlet opening 188 is aligned with a tangent (indicated at 211 in FIG. 10) of the effective radius so that the foam or other contents within the frothing chamber 112 are directed along the tangent through the outlet opening 188 for dispensing in part by the centripetal force generated by the rotating agitator 114.

Returning to FIG. 1, the generated foam may be dispensed through the outlet opening 188 and the port 190 into a secondary container 208 (e.g., a cup, pitcher, or other holding mechanism). The frothing system 100, in some embodiments, may include a manual or electrically controlled flow restrictor 210 at or adjacent to the outlet opening 188 that selectively prevents and permits the foam or other contents within the frothing chamber to flow out from the container 104. In other words, the foam or other contents within the frothing chamber may be prevented or permitting from flowing out of container 104 in response to the manual or electrically controlled operation of the flow restrictor. Examples of suitable flow restrictors 210 include manual or electrically controlled valves (e.g., a ball valve, gate valve, butterfly valve, globe valve, check valve, solenoid valve, diaphragm valve, needle valve, and a plug valve), covers, plugs, and/or the like. In the example embodiment shown in FIG. 1, the flow restrictor 210 includes a cover 212 movable (e.g., rotatable) between a closed state, in which the contents within the container 104 are prevented from dispensing from the container 104 (e.g., through the outlet opening 188 and/or the port 190), and an opened state, in which the contents within the container 104 are permitted to dispense from the container 104 (e.g., through the outlet opening 188 and/or the port 190). The cover 212 may be manually movable between the opened and closed states via an engagement projection 214 and/or automatically movable between the two states via a secondary motor 216 (e.g., an electric motor) of the flow restrictor 210.

In some operating scenarios, the flow restrictor 210 may be maintained in a closed state during foam production. In other operating scenarios, the flow restrictor 210 may be maintained in the opened state during processing and/or moved to the opened state mid-processing to allow the produced foam to be dispensed from the container 104 as it is generated. In either scenario, the agitator 114 may be rotated via the motor 120 during the dispensing of the foam to provide a force that helps expel the foam from the container 104. It should be appreciated that because of the provision of at least the outlet opening 188, the foam or other materials within the container 104 can be dispensed without the container 104 being picked up and tipped, thereby providing a less cumbersome dispensing process.

As shown in FIG. 1, the frothing system 100 may include a cleaning apparatus 218 for cleaning the portions of the container 104 (e.g., the frothing chamber 112, the outlet opening 188, the port 190, and/or the flow restrictor 210) and the portions of the frothing device 106 that are located in the frothing chamber 112 after or between frothing operations. The cleaning apparatus 218 may include a faucet head 220, a fluid source 222 fluidly connected to the faucet head 220, and a cleaning valve 224 openable and closable so as to selectively permit cleaning fluid (e.g., water and/or a cleaning solution) from the fluid source 222 to be delivered to the frothing chamber 112 via the faucet head 220. In embodiments, the fluid source 222 may be a refillable or non-refillable tank of cleaning fluid. In other embodiments, the fluid source 222 may be a cleaning fluid supply line (e.g., a water supply line) that delivers cleaning fluid to the frothing chamber 112 from a central source when prompted via the cleaning valve 224.

The faucet head 220 may (e.g., removably) extend through an opening 226 of the lid 116 into the frothing chamber 112 so as to provide cleaning fluid to the frothing chamber 112 when prompted. In other embodiments, the faucet head 220 may be located externally to the frothing chamber 112 and provide cleaning fluid to the frothing chamber 112 through the opening 226 in the lid 116. In yet other embodiments, the lid 116 may be free of the opening 226 and may be removed prior to the provision of cleaning fluid into the frothing chamber 112.

During a cleaning operation, cleaning fluid from the fluid source 222 is provided into the frothing chamber 112 via the faucet head 220. The agitator 114 may be rotated via the motor 120 after or as the cleaning fluid is added to the frothing chamber 112 to agitate the cleaning fluid in the frothing chamber 112 and assist in the cleaning of at least the frothing chamber 112 and the portions of the frothing device 106 that are located in the frothing chamber 112. The rotation of the agitator 114 may also assist with directing cleaning fluid and/or waste materials in the frothing chamber 112 through the outlet opening 188 and/or the port 190. Cleaning fluid and/or waste materials dispensed from the container 104 during or following the cleaning operation may be collected in the secondary container 208 or directed into a drain (not shown) that is adjacent to the outlet opening 188 and/or the port 190.

The frothing system 100 may include a controller 228 that is communicatively coupled to the motor 120 for controlling the motor 120. The controller 228 includes a processor and non-transitory electronic memory that stores a set of machine-readable instructions. The processor executes the machine-readable instructions stored in the non-transitory electronic memory. The processor may be any device capable of executing machine-readable instructions. For example, the processor may be an integrated circuit, a microchip, a computer, or any other computing device. The non-transitory electronic memory may include random access memory (RAM), read-only memory (ROM), flash memories, hard drives, or any device capable of storing machine-readable instructions such that the machine-readable instructions can be accessed by the processor. The machine-readable instructions include logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine-readable instructions and stored in the non-transitory electronic memory. Alternatively, the machine-readable instructions may be written in a hardware description language (HDL), such as logic implemented via either a field-programmable gate array (FPGA) configuration or an application-specific integrated circuit (ASIC), or their equivalents. The non-transitory electronic memory may be implemented as one memory module or a plurality of memory modules.

In embodiments, the controller 228 may receive a motor actuation signal from a user interface 230 corresponding to a requested actuation of the motor 120. Utilizing the motor actuation signal, the controller 228 instructs the motor 120 to rotate the agitator 114 at a preset RPM or at a user defined RPM that is included in the motor actuation signal. The motor 120 may be instructed to cease operation by the controller 228 after a preset duration, after a duration selected via the user interface 230, and/or in response to the controller 228 receiving a signal from the user interface 230 indicating that a deactivation of the motor is requested.

In embodiments, the controller 228 may be communicatively coupled to other mechanisms of the frothing system 100 for control thereof. For example, in embodiments, where the flow restrictor 210 is electrically controlled, electrically controlled portions of the flow restrictor (e.g., the secondary motor 216) may be communicatively coupled to the controller 228. The flow restrictor 210 may thus be instructed by the controller 228 to open in response to a dispensing signal from the user interface 230, after a selected duration (e.g., selected via the user interface 130) of a frothing operation has lapsed, after a predetermined duration of a frothing operation has lapsed, after a selected duration (e.g., selected via the user interface 130) of a cleaning operation has lapsed, and/or after a predetermined duration of a cleaning operation has lapsed. In embodiments, the cleaning valve 224 may be an electrically controlled cleaning valve and communicatively coupled to the controller 228. The cleaning valve 224 may thus be instructed by the controller 228 to open in response to a cleaning initiation signal from the user interface 230 and/or after a frothing operation.

In embodiments, the controller 228 may also be communicatively coupled to at least one secondary container sensor 232 that determines the presence of a secondary container 208 adjacent to the port 190 and/or the outlet opening 188. Each secondary container sensor 232 may be or include a pressure sensor, an optical sensor, a capacitive sensor, an ultrasonic sensor, a mechanical sensor, an inductive sensor, a magnetic sensor, a thermal sensor, and/or the like. When the secondary container sensor(s) 232 determine(s) that the secondary container 208 is present, the secondary container sensor(s) 232 transmit(s) a signal to the controller 228 indicating such presence. In response to the present signal, the controller 228 may instruct the motor 120 to rotate the agitator 114 for a frothing operation, the flow restrictor 210 to close for at least a portion of a frothing operation, the flow restrictor 210 to open for the dispensing of foam to the secondary container 208, the cleaning valve 224 to open for a cleaning operation, the motor 120 to rotate the agitator 114 for a cleaning operation, and/or the flow restrictor 210 to open for the dispensing of cleaning fluid and/or other waste materials to the secondary container 208. Similarly, the secondary container sensor(s) 232 may determine the absence of the secondary container 208 and transmit a signal to the controller 228 indicating such absence. In response to the absent signal, the controller 228 may instruct the cleaning valve 224 to open for a cleaning operation, the motor 120 to rotate the agitator for a cleaning operation, the flow restrictor 210 to close for a cleaning operation, and/or the flow restrictor 210 to open for the dispensing of cleaning fluid and/or other waste materials from the container 104 to, e.g., a drain.

In embodiments, the frothing system 100 may include at least one temperature regulator 234 adjacent to, on, or in the frothing chamber 112 so as to regulate (e.g., raise, lower, or maintain) a temperature of the ingredients, the foam, and/or the cleaning fluid within the frothing chamber 112. Each temperature regulator 234 may be or include one or more electric resistance coils, ceramic heating elements, positive temperature coefficient heating elements, immersion heaters, induction heating coils, Peltier junction devices, and/or the like. In embodiments, the frothing system 100 may also include at least one temperature sensor 236 adjacent to, on, or in the frothing chamber 112 for measuring the temperature of the ingredients, the foam, and/or the cleaning fluid within the frothing chamber 112. Each temperature sensor 236 may be or include, for example, one or more thermistors, thermocouples, resistance temperature detectors, integrated circuit sensors, silicone diode sensors, infrared thermometers, optical pyrometers, bimetallic thermometers, and/or the like.

In embodiments, the temperature regulator(s) 234 and the temperature sensor(s) 236 may be communicatively coupled to the controller 228. The temperature regulator(s) 234 may thus be instructed by the controller 228 to raise, lower, or maintain a selected temperature for the contents within the frothing chamber 112 in response to a temperature signal from the user interface 230, and/or to raise, lower, or maintain a preset temperature within the frothing chamber 112. Temperature measurements transmitted to the controller 228 from the temperature sensor(s) 236 may be utilized by the controller 228 to achieve the selected and/or preset temperature.

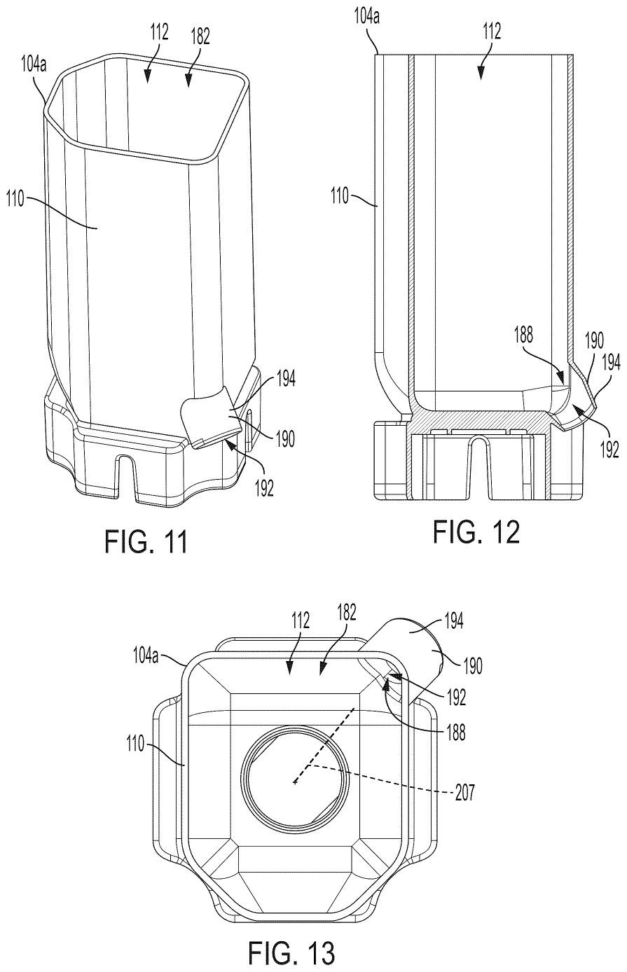

FIGS. 11-20 depict other embodiments of the container 104a, 104b, 104c, 104d having the same or like parts as the container 104 of FIGS. 1 and 6-10. Therefore, the functionality, operation, and/or alternatives of the same or like parts can be incorporated from the above for brevity. Furthermore, individual components of each embodiment of the container 104, 104a, 104b, 104c, 104d may be incorporated into each of the other embodiments whether expressly stated or not.

Therefore, the container 104a of FIGS. 11-13 thus is similar to the container 104 of FIGS. 1 and 6-10, with some of the differences being noted below. Unlike the container 104 of FIGS. 1 and 6-10, the side walls 110 of the container 104a of FIGS. 11-13 do not define a rounded portion 180 of the frothing chamber 112, just a polygonal portion 182. Further, the outlet opening 188 of the container 104a extends at a decline through a corner where two of the side walls 110 meet and the base 178. Instead of being aligned with a tangent of the effective radius in the frothing chamber 112, the outlet opening 188 of the container 104a is aligned with the effective radius (indicated at 207 in FIG. 13) so that foam and/or other contents within the frothing chamber 112 is/are directed along the effective radius through the outlet opening for dispensing. Although the container 104a includes a port 190 like the container 104 of FIGS. 1 and 6-10, the port 190 of the container 104a includes the first port portion 194 (e.g., the portion that extends at a decline from the outlet opening 188). The frothing system 100 may include an extender (not shown) that is removably coupled to the port 190 of the containers 104, 104a of FIGS. 1 and 6-10 and FIGS. 11-13 disclosed or constructed in view of the teachings herein so as to increase an effective length of the port 190 and the inner lumen 192 of the port 190.

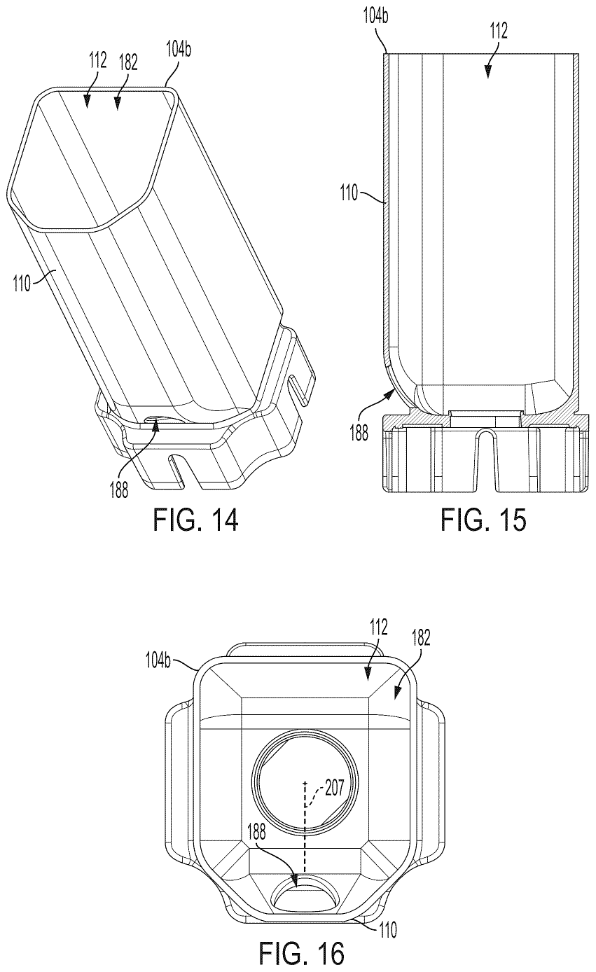

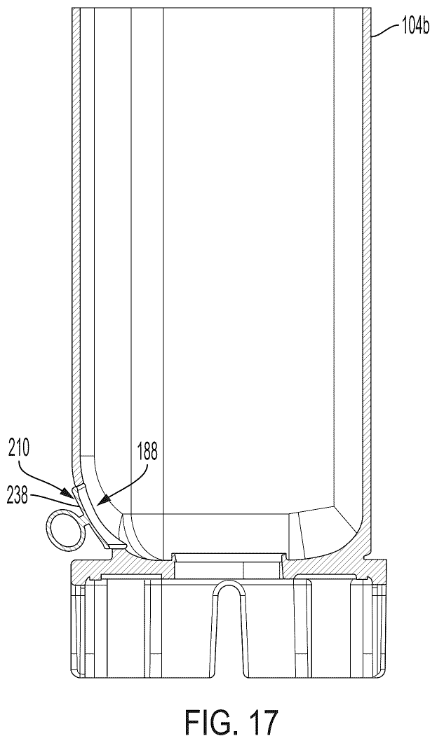

The container 104b of FIGS. 14-16 is substantially similar to that of the container 104a of FIGS. 11-13, with some differences being noted below. Unlike in the container 104a of FIGS. 11-13, the outlet opening 188 of the container 104b of FIGS. 14-16 is located on one of the side walls 110 and not at a corner where two of the side walls 110 meet. Furthermore, the container 104b of FIGS. 14-16 is free of the port 190 so that foam, cleaning fluid, and/or waste materials may be dispensed directly through the outlet opening 188 and to a secondary container 208 and/or a drain. As shown in FIG. 17, the container 104 may utilize a flow restrictor 210 in the form of a plug 238. In a closed state (FIG. 17), the plug 238 may be removably inserted into the outlet opening 188 so as to prevent the dispensing of the contents within the frothing chamber 112. The plug 238 may be removed from the outlet opening 188 in the opened state to permit the dispensing. In other embodiments, the container 104b may include the cover 212 and secondary motor 216 of FIG. 1 or any other suitable flow restrictor 210 in or adjacent to the outlet opening 188 for selectively preventing and permitting the dispensing of the contents of the frothing chamber 112.

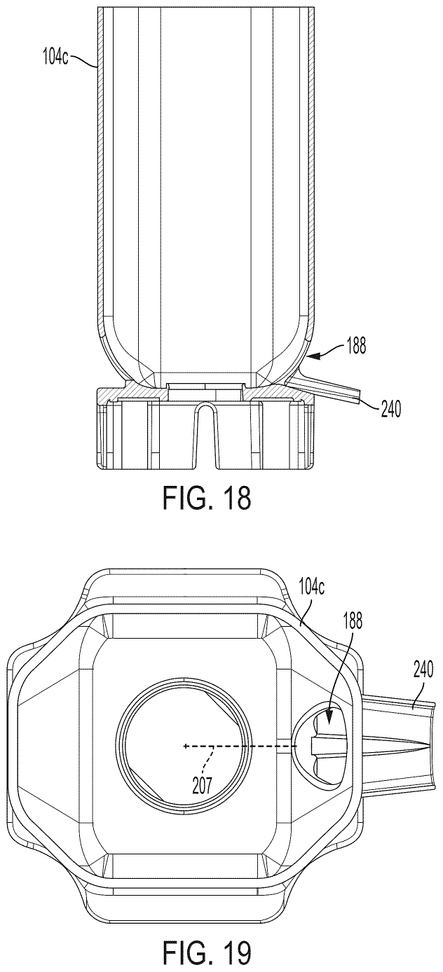

The container 104c of FIGS. 18-19 is substantially similar to the container 104b of FIGS. 14-16, with one of the differences being that the container 104c includes a ramp 240 that extends at a decline from the outlet opening 188 for assisting in the dispensing of the contents of the frothing chamber 112. Like the container 104b of FIGS. 14-16, the container 104c of FIGS. 18-19 may utilize a plug 238, a cover 212 and secondary motor 216, or any other flow restrictor 210 for selectively preventing and permitting the dispensing of the contents of the frothing chamber 112.

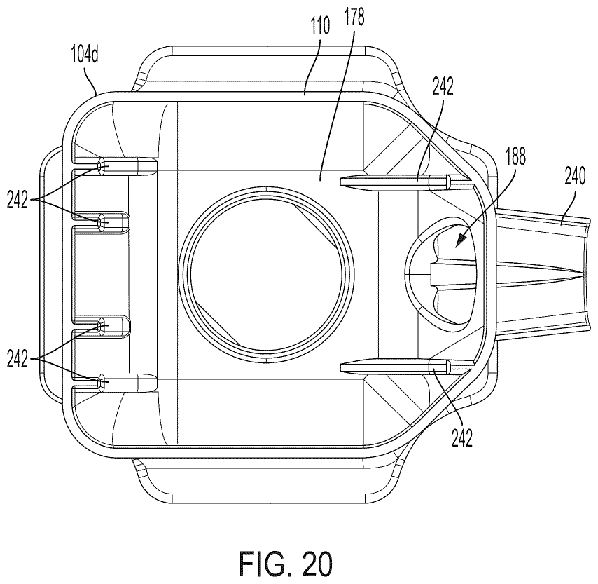

The container 104d of FIG. 20 is substantially the same as the container 104c of FIGS. 18-19, except that the container 104d includes ribs 242 in the frothing chamber 112 (e.g., connected to one or more side walls 110 and/or the base 178) that may assist in directing the flow of the foam or other contents of the frothing chamber 112 toward the outlet opening 188, generating the vortex, avoiding high pressure within the ingredients and/or foam, and/or the formation of eddies. It should be appreciated that these or similar ribs 242 may be incorporated into each of the other embodiments of the container 104, 104a, 104b, 104c despite only being shown in the container 104d of FIG. 20.

It should be appreciated that any of the embodiments of the container 104, 104a, 104b, 104c, 104d disclosed herein or constructed in view of the teachings herein may be utilized with any of the embodiments of the frothing device 106, 106a, 106b disclosed herein or constructed in view of the teachings herein. Furthermore, any of the embodiments of the container 104, 104a, 104b, 104c, 104d and/or the frothing device 106, 106a, 106b disclosed herein or constructed in view of the teachings herein may be utilized with any system base 102 disclosed or constructed in view of the teachings herein or any other suitable base.

Further aspects of the aspects described herein are provided by the subject matter of the following clauses:

A frothing system, comprising: a container having a base and at least one side wall extending from the base; and a frothing device attached to the base of the container, the frothing device comprising: a spindle having a first spindle end and a second spindle end, the spindle defining and being rotatable about a spindle axis; a support having a first support portion coupled to the first spindle end and a second support portion spaced from the first spindle end, the second support portion being adjacent the base; and an agitator on the second support portion and adjacent to the base, the agitator positioned closer to the base than the first support portion.

The frothing system of any preceding clause, wherein the coupling of the first support portion to the first spindle end rotationally fixes the second support portion and the agitator to the spindle.

The frothing system of any preceding clause, wherein the agitator is less than 0.5 inches from the base.

The frothing system of any preceding clause, wherein the agitator is separate from and mounted to the second support portion.

The frothing system of any preceding clause, wherein the agitator is a wire coiled about the second support portion.

The frothing system of any preceding clause, wherein the second support portion and the agitator are a one-piece construction.

The frothing system of any preceding clause, wherein the second support portion includes a ring-shaped body that extends about the spindle axis.

The frothing system of any preceding clause, wherein the first support portion includes a ring that is coaxial with the ring-shaped body of the second support portion, the ring-shaped body of the second support portion having a greater diameter than the ring of the first support portion.

The frothing system of any preceding clause, wherein the support has an intermediate support portion extending between and interconnecting the ring-shaped body of the second support portion and the ring of the first support portion, and wherein the second support portion and the agitator are spaced from the first spindle end via the intermediate support portion.

The frothing system of any preceding clause, wherein the container comprises an outlet opening extending through the at least one side wall adjacent the base.

The frothing system of any preceding clause, wherein the outlet opening extends at a decline through the at least one side wall.

The frothing system of any preceding clause, further comprising a ramp extending at a decline from the outlet opening.

The frothing system of any preceding clause, further comprising a port extending at a decline from the outlet opening, the port defining an inner lumen that is in fluid communication with the outlet opening.

The frothing system of any preceding clause, wherein the outlet opening is aligned with an effective radius of the container.

The frothing system of any preceding clause, wherein the outlet opening is aligned with a tangent of the effective radius of the container.

The frothing system of any preceding clause, wherein the container comprises a flow restrictor in or adjacent to the outlet opening that selectively permits contents within the container to flow out from the container and selectively prevents the contents within the container from flowing out from the container.

The frothing system of any preceding clause, wherein the frothing device is removably attached to the base of the container.

The frothing system of any preceding clause, further comprising a system base having a motor, the motor being removably coupled to the second spindle end, the motor selectively rotating the spindle about the spindle axis.

A frothing system, comprising: a system base having a motor; a container coupled to the system base, the container comprising: a base; at least one side wall extending from the base and terminating at an open end of the container; and an outlet opening extending through the at least one side wall adjacent the base surface and through which contents within the container flow out from the container; and a frothing device coupled to the base of the container, the frothing device comprising: a spindle having a first spindle end and a second spindle end, the spindle defining a spindle axis, the second spindle end being coupled to the motor and rotatable via the motor about the spindle axis; a support having a first support portion coupled to the first spindle end and a second support portion spaced from the first spindle end; and an agitator on the second support portion, the agitator positioned closer to the base than the first support portion, and wherein the coupling of the first support portion to the first spindle end rotationally fixes the second support portion and the agitator to the spindle.

The frothing system of any preceding clause, wherein the agitator is separate from and mounted to the second support portion.

The frothing system of any preceding clause, wherein the second support portion and the agitator are a one-piece construction.

The frothing system of any preceding clause, wherein the container comprises a flow restrictor in or adjacent to the outlet opening that selectively permits contents within the container to flow out from the container and selectively prevents the contents within the container from flowing out from the container.

The frothing system of any preceding clause, wherein the container is removably coupled to the system base, the frothing device is removably coupled to the base of the container, and the second spindle end is coupled to the motor when the frothing device is coupled to the base and the container is coupled to the system base.

A frothing device, comprising: a spindle having a first spindle end and a second spindle end, the spindle defining a spindle axis; a support comprising: a ring coupled to the first spindle end, the ring extending about the spindle axis; and a ring-shaped body connected to the ring and spaced from the first spindle end, the ring-shaped body having a greater diameter than a diameter of the ring, the ring-shaped body extending about the spindle axis; and an agitator mounted to or formed with the ring-shaped body, the agitator being spaced from the first spindle end.

The frothing device of any preceding clause, wherein the ring comprises an inner ring coupled to the first spindle end and an outer ring connected to the inner ring, the outer ring being coaxial and co-planar with the inner ring, and wherein the ring-shaped body is connected to the outer ring.

From the above, it is to be appreciated that defined herein are frothing systems and devices that include a spindle, a support coupled to the spindle at a first portion, and an agitator on a second portion of the support. The agitators of the frothing systems are adjacent to a base of a container, closer to a base of a container than where the first portion is connected to the spindle, and/or spaced from an end of the spindle to which the first portion is connected. Such agitator positioning minimizes the retention of un-processed and/or processed materials within the container and provides for a more efficient processing of the ingredients.

It is also to be appreciated that defined herein are frothing systems having containers with outlet openings through which contents within the containers may flow out from the container. Accordingly, having such an outlet opening provides for a less cumbersome dispensing process, as contents within a container can be dispensed without picking up the container.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A frothing system, comprising:
a container having a base and at least one side wall extending from the base; and
a frothing device attached to the base of the container, the frothing device comprising:
a spindle having a first spindle end and a second spindle end, the spindle defining and being rotatable about a spindle axis;
a support having a first support portion coupled to the first spindle end and a second support portion spaced from the first spindle end, the second support portion being adjacent the base; and
an agitator on the second support portion, the agitator positioned closer to the base than the first support portion.

2. The frothing system of claim 1, wherein the coupling of the first support portion to the first spindle end rotationally fixes the second support portion and the agitator to the spindle.

3. The frothing system of claim 1, wherein the agitator is less than 0.5 inches from the base.

4. The frothing system of claim 1, wherein the agitator is separate from and mounted to the second support portion.

5. The frothing system of claim 4, wherein the agitator is a wire coiled about the second support portion.

6. The frothing system of claim 1, wherein the second support portion and the agitator are a one-piece construction.

7. The frothing system of claim 1, wherein the second support portion includes a ring-shaped body that extends about the spindle axis.

8. The frothing system of claim 7, wherein first support portion includes a ring that is coaxial with the ring-shaped body of the second support portion, the ring-shaped body of the second support portion having a greater diameter than the ring of the first support portion.

9. The frothing system of claim 8, wherein the support has an intermediate support portion extending between and interconnecting the ring-shaped body of the second support portion and the ring of the first support portion, and
wherein the second support portion and the agitator are spaced from the first spindle end via the intermediate support portion.

10. The frothing system of claim 1, wherein the container comprises an outlet opening extending through the at least one side wall adjacent the base.

11. (canceled)

12. The frothing system of claim 10, further comprising a ramp extending at a decline from the outlet opening.

13. The frothing system of claim 10, further comprising a port extending at a decline from the outlet opening, the port defining an inner lumen that is in fluid communication with the outlet opening.

14. (canceled)

15. The frothing system of claim 10, wherein the outlet opening is aligned with a tangent of the effective radius of the container.

16. The frothing system of claim 10, wherein the container comprises a flow restrictor in or adjacent to the outlet opening that selectively permits contents within the container to flow out from the container and selectively prevents the contents within the container from flowing out from the container.

17. (canceled)

18. A frothing system, comprising:
a system base having a motor;
a container coupled to the system base, the container comprising:
a base;
at least one side wall extending from the base and terminating at an open end of the container; and
an outlet opening extending through the at least one side wall adjacent the base surface and through which contents within the container flow out from the container; and
a frothing device coupled to the base of the container, the frothing device comprising:
a spindle having a first spindle end and a second spindle end, the spindle defining a spindle axis, the second spindle end being coupled to the motor and rotatable via the motor about the spindle axis;
a support having a first support portion coupled to the first spindle end and a second support portion spaced from the first spindle end; and
an agitator on the second support portion, the agitator positioned closer to the base than the first support portion, and
wherein the coupling of the first support portion to the first spindle end rotationally fixes the second support portion and the agitator to the spindle.

19. The frothing system of claim 18, wherein the agitator is separate from and mounted to the second support portion.

20. The frothing system of claim 18, wherein the second support portion and the agitator are a one-piece construction.

21. The frothing system of claim 18, wherein the container comprises a flow restrictor in or adjacent to the outlet opening that selectively permits contents within the container to flow out from the container and selectively prevents the contents within the container from flowing out from the container.

22. (canceled)

23. A frothing device, comprising:
a spindle having a first spindle end and a second spindle end, the spindle defining a spindle axis;
a support comprising:
a ring coupled to the first spindle end, the ring extending about the spindle axis; and
a ring-shaped body connected to the ring and spaced from the first spindle end, the ring-shaped body having a greater diameter than a diameter of the ring, the ring-shaped body extending about the spindle axis; and
an agitator mounted to or formed with the ring-shaped body, the agitator being spaced from the first spindle end.

24. The frothing device of claim 23, wherein the ring comprises an inner ring coupled to the first spindle end and an outer ring connected to the inner ring, the outer ring being coaxial and co-planar with the inner ring, and
wherein the ring-shaped body is connected to the outer ring.
